(19) United States
(12) Patent Application Publication
(10) Pub. No.: US 2019/0010336 A1
(43) Pub. Date: Jan. 10, 2019

(54) ACTIVE COMPONENT FOR PAINT PRODUCTS, ITS PREPARATION AND USES

(71) Applicant: Sergio Giorgetti Filho, Milano (IT)

(72) Inventor: Sergio Giorgetti Filho, Milano (IT)

(21) Appl. No.: 16/081,077

(22) PCT Filed: Feb. 27, 2017
(86) PCT No.: PCT/IB2017/051128

§ 371 Date: Aug. 30, 2018

(30) Foreign Application Priority Data
Mar. 2, 2016 (IT) 102016000022058

(51) Int. Cl. C09D 5/14; A01N 25/08; A01N 25/28

(52) U.S. Cl. CPC C09D 5/14; A01N 25/28; A01N 25/08

(57) ABSTRACT

An active component for paint products is disclosed, comprising at least one active agent against insects which is microencapsulated or adsorbed on a mineral adsorbent, and at least one synergistic agent, which is microencapsulated or adsorbed on a mineral adsorbent together with the at least one active agent against insects or separately and independently of the latter. A process for preparing the active component and uses for internal or external applications, in both industrial and civil sectors are also disclosed.

### DESCRIPTION

### Field of the Invention

The present invention concerns an active component for paint products, comprising at least one active agent against insects which is microencapsulated or adsorbed on a mineral adsorbent, and at least one synergistic agent, which is microencapsulated or adsorbed on a mineral adsorbent together with the at least one active agent against insects or separately and independently of the latter.

The present invention also concerns a process for preparing the active component and uses for internal or external applications, in both industrial and civil sectors.

### State of the Art

Civil and industrial buildings are seasonally affected by the undesired, and often dangerous, presence of pests such as flies, crouches, ants, spiders, silverfish, fleas, mosquitoes, which are not only noisy, but also can cause severe health problems to human beings.

Traditional pest control products often offer only temporary control. The frequent application of these products not only time consuming, they are also costly.

It is therefore an object of the present invention to provide an effective and long lasting active product, which overcome the drawbacks of the known products.

### SUMMARY OF THE INVENTION

The above object has been achieved by an active component for paint products, as claimed in claim 1.

With the term “paint” or “paint product”, it is meant to include any composition suitable to be applied to a surface, either comprising a colouring agent or not, such as primer, flat finish paint, matte finish, eggshell finish, pearl (satin) finish, semi-gloss finish, varnish, shellac, wood stain, lacquer, enamel, glaze, roof coating, finger-paint, ink, anti-graffiti coating, anti-climb paint, anti-fouling paint, insulative paint, anti-slip paint, road marking paint, luminous paint, and combinations thereof.

In a further aspect, the present invention concerns a process for preparing the active component for paint products.

In an additional aspect, the present invention concerns the use of the active component for paint products for activating a surface, as well as a paint product comprising the active component.

With the term “surface”, it is meant to include any industrial and civil, internal or external surface, either already coloured or raw.

The characteristics and the advantages of the present invention will become apparent from the following detailed description and from the working examples provided for illustrative purposes.

### DETAILED DESCRIPTION OF THE INVENTION

The subject of the invention therefore is an active component for paint products, said component comprising at least one active agent against insects, at least one synergistic agent and additives, said active agent against insects being an insect repellent, an insecticide, or a mixture thereof, wherein said at least one active agent against insects is microencapsulated or adsorbed on a mineral adsorbent, and said at least one synergistic agent is microencapsulated or adsorbed on a mineral adsorbent together with the at least one active agent against insects or separately and independently of the latter.

When said at least one synergistic agent is microencapsulated or adsorbed on a mineral adsorbent together with the at least one active agent against insects, it means that a mixture of said at least one synergistic agent and said at least one active agent is microencapsulated or adsorbed on a mineral adsorbent.

When said at least one synergistic agent is microencapsulated or adsorbed on a mineral adsorbent separately and independently of the at least one active agent against insects, it means that the active component comprises:
microcapsules including at least one active agent against insects, and microcapsules including at least one synergistic agent, or
microcapsules including at least one active agent against insects, and at least one synergistic agent adsorbed on a mineral adsorbent, or
microcapsules including at least one synergistic agent, and at least one active agent against insects adsorbed on a mineral adsorbent, or
at least one active agent against insects adsorbed on a mineral adsorbent, and at least one synergistic agent adsorbed on a mineral adsorbent.

It has been surprisingly found that the microencapsulation or adsorption on adsorbent material of said active agent allows to obtain a prolonged effect against insects of the active agent itself. In fact, it is possible to control the release of the active agent by suitably setting the microencapsulation or adsorption on adsorbent material, so that the activity is properly modulated once the paint product including the active component is applied on a surface.

This active component thus overcome the drawbacks of the repeated applications of known products, at the same time being also more convenient under the economical point of view.

This effect against insects is advantageously and significantly improved by the presence of the at least one synergistic agent.

The term “synergistic agent” means a product that does not possess activity against insects itself, but which sensitises the insect to insecticide treatment, for example by reducing/inhibiting insect detoxification systems useful for eliminating the insecticide. An important consequence of the synergistic agent is that, by enhancing the activity of a given insecticide, a reduced amount of the latter can be used to achieve the same result. Synergist agents significantly improve the efficacy, particularly when problems of resistance have arisen. These natural or synthetic chemicals, which increase the lethality and effectiveness of active agents against insects, are by themselves considered nontoxic. The way of action of the majority of synergist agents is to block the metabolic systems that would otherwise break down insecticide molecules. They interfere with the detoxication of insecticides through their action on polysubstrate monooxygenases (PSMOs) and other enzyme systems. The role of synergist agents in resistance management is related directly to an enzyme-inhibiting action, restoring the susceptibility of insects to the chemical, which would otherwise require higher levels of the toxicant for their control. For this reason, synergist agents are considered straightforward tools for overcoming metabolic resistance, and can also delay the manifestation of resistance.

Said at least one synergistic agent is preferably selected from piperonyl butoxide, sesame, sulfoxide, and mixtures thereof.

Piperonyl butoxide (PBO) is a waxy white solid. It is a semisynthetic derivative of safrole.

Sesamex, also called sesoxane, is an organic compound, known to enhance the potency of pesticides such pyrethrins and pyrethroids, even though Sesamex itself is not a pesticide.

Sulfoxide, also called sulphoxide, is any of a class of organic compounds containing sulfur and oxygen and having the general formula (RR')SO, in which R and R′ are a grouping of carbon and hydrogen atoms. The sulfoxides are good solvents for salts and polar compounds.

Preferably, said at least one active agent is in an amount up to 40 wt %, on the weight of the active component.

More preferably, said at least one active agent is in an amount up to 20 wt %, on the weight of the active component.

Preferably, said at least one synergist agent is in an amount up to 50 wt %, on the weight of the active component.

More preferably, said at least one synergist agent is in an amount up to 30 wt %, on the weight of the active component.

In preferred embodiments, said at least one synergist agent is in an amount higher than said active agent. More preferably, said at least one synergist agent and said active agent are in a weight ratio of 2:1 to 20:1.

Preferably, said mineral adsorbent is in a powder form.

In preferred embodiments, said mineral adsorbent is zeolite or sepiolite.

In more preferred embodiments, said mineral adsorbent is sepiolite.

In the most preferred embodiments, sepiolite is modified sepiolite.

With the term “modified sepiolite”, it is meant sepiolite resulting from a purification treatment. In fact, the ore sepiolite is not pure, due to the typical presence of talc, quartz, calcite and dolomite, and thus needs to be treated and purified. For the purposes of the controlled release of an active agent according to the present invention, purification and acid activation of the ore sepiolite are carried out, by performing the following steps: immersion in water, high speed dispersion, rest and settlement of the mass, residue formation on the filter, dehydration and acid activation, washing, filtering and milling, and optionally stoving. The resulting powdered sepiolite has chemical stability, enhanced surface area, and improved surface activity, thus further enhancing the adsorption capacity.

One or more active agents are added in the modified sepiolite powder and rest 24 hours to allow a good adsorption thereof. The duration of the effect of the final active paint can be modulated by setting the amount of adsorbed active agent on modified powder sepiolite, or by controlling, during the sepiolite treatment process, the sepiolite adsorption time: the shorter the adsorption time, the shorter the duration of the effect.

In some embodiments, the active component comprises at least one active agent, wherein a first part thereof is microencapsulated and a second part thereof is adsorbed on a mineral adsorbent.

In other embodiments, the active component comprises at least one synergist agent, wherein a first part thereof is microencapsulated and a second part thereof is adsorbed on a mineral adsorbent.

In other embodiments, the active component further comprises free active agent, i.e. active agent neither microencapsulated nor adsorbed on a mineral adsorbent.

In other embodiments, the active component further comprises free synergist agent, i.e. synergist agent neither microencapsulated nor adsorbed on a mineral adsorbent.

In further embodiments, the active component comprises at least one active agent, wherein a first part thereof is microencapsulated, a second part thereof is adsorbed on a mineral adsorbent, and a third part is free active agent.

In further embodiments, the active component comprises at least one synergist agent, wherein a first part thereof is microencapsulated, a second part thereof is adsorbed on a mineral adsorbent, and a third part is free synergist agent.

In additional embodiments, the active component comprises at least one active agent microencapsulated and at least one synergistic agent microencapsulated. This means that the active component comprises microcapsules containing at least one active agent and microcapsules containing at least one synergistic agent.

In additional embodiments, the active component comprises at least one active agent adsorbed on a mineral adsorbent and, separately and independently, at least one synergistic agent adsorbed on a mineral adsorbent.

In additional embodiments, the active component comprises at least one active agent adsorbed on a mineral adsorbent and at least one synergistic agent microencapsulated.

In additional embodiments, the active component comprises at least one active agent microencapsulated and at least one synergistic agent adsorbed on a mineral adsorbent.

In other embodiments, the active component comprises microcapsules comprising a mixture of at least one active agent and at least one synergistic agent.

In other embodiments, the active component comprises a mixture of at least one active agent and at least one synergistic agent adsorbed on a mineral adsorbent.

In yet additional embodiments, the active component further comprises at least one free active agent, at least one free synergistic agent, or a mixture thereof.

The percentage of microencapsulated or adsorbed active agent with respect to free active agent on the total amount of the active agent in the active component depends on the desired prolonged effect, i.e. from a few days to several months. In fact, in cases where a sustained release is desired, the percentage of microencapsulated or adsorbed active agent is low, whereas conversely, in cases where an extended release is desired, the percentage of microencapsulated or adsorbed active agent is higher.

The prolonged effect from a few days to several months can be also modulated by selecting the membrane thickness of the microcapsules and the amount of microcapsules used in the active paint, or by setting the adsorption parameters of the active agent on the mineral adsorbent, such as temperature, pressure and surface area. The intensity of the effect is increased by increasing the amount of the synergist agent. Microcapsules are preferred in case the active agent has a strong or unpleasant odour. The active agent in the active component can be in a liquid or a solid state, particularly can be in the form of an extract, powder, oil, granules, concentrate, solution, emulsion, particulate, and mixture thereof.

Said active agent can be an insect repellent. An insect repellent is a substance which discourages insects from landing or climbing on a surface. Insect repellents help prevent and control the outbreak of insect-borne diseases such as malaria, Lyme disease, dengue fever, bubonic plague, and West Nile fever. Pest animals commonly serving as vectors for disease include insects such as flea, fly, and mosquito; and the arachnid tick. Said insect repellent can be selected from the group consisting of Achillea alpine, alphaterpinene, Basil, Callicarpa Americana, Breadfruit, Camphor, Capsicum, Carvacrol, Castor oil, Catnip oil, Cedar oil, Celery extract, Cinnamon, Citronella oil, Oil of cloves, Eucalyptus oil, Fennel oil, Garlic, Geranium oil, Lavender, Lemon eucalyptus, Lemongrass oil, Marigolds, Marjoram, Neem oil, Oleic acid, Pennyroyal, Peppermint,

Pyrethrum, Rosemary, Sophora flavescens, Spanish Flag, Tea tree oil, Thyme, Yellow Nightshade, Andrographis paniculata, N,N-Diethyl-meta-toluamide (DEET), picaridin, ethyl butylacetylamino-propionate, p-menthane-3,8-diol, and combinations thereof. Said active agent can be insecticide. An insecticide is a substance used to kill insects, and includes ovicides and larvicides used against insect eggs and larvae, respectively. Said insecticide can be selected from the group consisting of Organochlorides, Organophosphates, Carbamates, Pyrethroids, Neonicotinoids, Ryanoids, Insect growth regulators, Plant-derived insecticides, Inorganic insecticides, and combinations thereof. Particularly, said insecticide can be Aldrin, Chlordane, Chlordecone, Dieldrin, Endosulfan, Endrin, Heptachlor, Hexachlorobenzene, Lindane, Methoxychlor, Mirex, Pentachlorophenol, TDE, Acephate, Azinphos -methyl, Bensulide, Chlorethoxyfos, Chlorpyrifos, Chlorpyriphos-methyl, Diazinon, Dichlorvos, Dicrotophos, Dimethoate, Disulfoton, Ethoprop, Fenamiphos, Fenitrothion, Fenthion, Fosthiazate, Malathion, Methamidophos, Methidathion, Mevinphos, Monocrotophos, Naled, Omethoate, Oxydemeton-methyl, Parathion, Parathion-methyl, Phorate, Phosalone, Phosmet, Phostebupirim, Phoxim, Pirimiphos -methyl, Profenofos, Terbufos, Tetrachlorvinphos, Tribufos, Trichlorfon, Aldicarb, Bendiocarb, Carbofuran, Carbaryl, Dioxacarb,

Fenobucarb, Fenoxycarb, Isoprocarb, Methomyl, 2-(1-Methylpropyl)phenyl methylcarbamate, Allethrin, Bifenthrin, Cyhalothrin, Cypermethrin, Cyfluthrin, Deltamethrin, Etofenprox, Fenvalerate, Permethrin, Phenothrin, Prallethrin, Resmethrin, Tetramethrin, Tralomethrin, Transfluthrin, Acetamiprid, Clothianidin, Imidacloprid, Nithiazine, Thiacloprid, Thiamethoxam, Chlorantraniliprole, Cyantraniliprole, Flubendiamide, Diflubenzuron, Flufenoxuron, Methoprene, Hydroprene, Tebufenozide, Anabasine, Anethole, Annonin, Asimina, Azadirachtin, Caffeine, Carapa, Cinnamaldehyde, Cinnamon, Cinnamyl acetate, Citral, Deguelin, Derris, Desmodium caudatum, Eugenol, Linalool, Myristicin, Neem, Nicotiana rustica, Peganum harmala, Oregano oil, Polyketide, Pyrethrum, Quassia, Ryanodine, Tetranortriterpenoid, Thymol, Diatomaceous earth, Borate, Borax, Boric Acid, or a combination thereof.

Said active agent can be also a mixture of an insect repellent and an insecticide.

Said active component for paint products can also comprise a sanitizer. A sanitizer is a type of antimicrobial that (according to EPA specifications) kills or irreversibly inactivates at least 99.9 percent of all bacteria, fungi, and viruses (called microbials, microbiologicals, microorganisms) present on a surface. Most sanitizers are based on toxic chemicals such as chlorine, iodine, phenol, or quaternary ammonium compounds, and which (unlike some antiseptics) may never be taken internally.

Said sanitizer can be selected from the group consisting of aldehydes, anilides, biguanides, bis-phenols, quaternary ammonium compounds, cetyl pyridium chloride, cetrimide, alexidine, chlorhexidine, chlorhexidine gluconate, chlorhexidine digluconate, chlorhexidine diacetate, benzalkonium chloride, o-phthalaldehyde, and combinations thereof.

The active component further comprises additives, preferably dispersing agents. However, suitable additives can be also water, inert compounds, resins, humectants, film-forming agents, defoamers, antifouling agents, antioxidants, anti-foaming agents, surfactants, super-adsorbent polymers, and mixtures thereof.

Particularly, said resins are important for the application as well as for the adhesion and drying on a surface. Preferred resins are synthetic or natural resins, such as alkyds, acrylics, vinyl acrylic (PVA), styrene acrylic, vinyl acetate/ethylene (VAE), polyurethanes, polyesters, melamine resins, epoxy resins, oil resins and mixtures thereof.

In some embodiments wherein the active component comprises microcapsules, as above described, the membrane of said microcapsules comprises UV-screening agents, that can be chemical sunscreening agents, physical sunscreening agents or mixtures thereof. These membranes protect and get longer lifetime to active ingredients microencapsulated therein. This results in a higher efficiency and a long lasting effect of the active ingredients, once exposed to sunlight or also to UV rays produced by electric arcs and specialized lights, such as mercury-vapor lamps, tanning lamps, and black lights.

Chemical sunscreening agents, such as bemotrizinol, avobenzone, bisoctizole, benzophenone-3 (BZ-3, oxybenzone), and octocrylene, are broad-spectrum agents and are effective against a broad range of solar spectrum both in experimental models and outdoor settings. Ecamsule (terephthalylidene dicamphor sulphonic acid), dometrizole trisiloxane, bemotrizinol, and bisoctrizole are considered organic UVA sunscreening agents.

Physical sunscreening agents are zinc oxide, titanium dioxide, magnesium oxide, iron oxide, kaolin, or mixtures thereof.

Chemical sunscreening agents absorb high-energy UV rays, whereas physical sunscreening agents reflect or scatter light. Mixtures of chemical sunscreening agents and physical sunscreening agents are usually preferred in order to achieve protection against a broader range of the UV spectrum. Inorganic particulates may increase the optical pathway of photons, leading to absorption of more photons and enhancing the sun protection factor (SPF).

Additionally, the breathability of the active component can be improved by adding pore-forming agents that enhance the release of active agents into a paint product and, after application and drying, through the micropores into the environment. This pore-forming agent may be for example a silane-based compound.

In some embodiments, the active component can further comprise a bactericidal agent, an antifungal agent, or a mixture thereof.

Some preferred embodiments are those wherein the active component comprises:

| | |
|---|---|
| agent | 1.50-90.00% |
| Dispersant agent | 1.00-7.00% |
| Defoamers | 1.00-5.00% |
| Antifouling agents | 2.00-10.00% |
| Water | balance to 100.00% |

wherein “%” means wt % based on the active component weight.

Other preferred embodiments are those wherein the active component comprises:

| | |
|---|---|
| Resins | 5.00-30.00% |
| Microcapsules and/or mineral adsorbent, comprising | up to 50.00% |
| a mixture of active ingredient and synergistic agent or, | |
| separately and independently active agent and | |
| synergistic agent | |
| Free active agent and/or free synergistic agent | 0.00-12.00% |
| Dispersant agent | up to 5.00% |
| Other additives | up to 40.00% |
| Water | balance to 100% |

Particularly preferred embodiments comprise:

| | |
|---|---|
| Resins | 10.00-25.00% |
| Microcapsules and/or modified sepiolite, comprising | up to 40.00% |
| active agent and/or PBO | |
| Free active agent and/or free synergistic agent | up to 10.00% |
| Dispersant agent | 0.10-2.00% |
| Other additives | up to 40.00% |
| Water | balance to 100% |

The most preferred embodiments comprise:

| | |
|---|---|
| Resins | 15.00-25.00% |
| Microcapsules and/or modified sepiolite, comprising | 0.15-30.00% |
| a mixture of active ingredient and synergistic agent | |
| Free active agent and/or free synergistic agent | 0.15-10.00% |
| Dispersant agent | 0.20-1.00% |
| Inerts | 25.00-35.00% |
| TiO₂ | 0.50-20.00% |
| Pore-forming agent | 0.50-4.50% |
| Absorbent Polymer | 0.10-3.00% |
| Humectants | 0.10-3.00% |
| Film-forming agent | 0.10-3.00% |
| Antioxidant | 0.10-3.00% |
| Anti-foaming agent | 0.10-3.00% |
| Surfactant | 0.10-3.00% |
| Water | balance to 100% |

In a further aspect, the present invention relates to the use of the active component above described as an ingredient for making paint products having repellent or insecticide activity. It should be understood that all aspects identified as preferred and advantageous for the active component are to be deemed as similarly preferred and advantageous also for the use of the same.

In tests performed by the Applicant, it has been observed that surfaces painted with a paint product comprising the active component of the invention, show an efficient and satisfactory repellent and insecticide activity for at a minimum 5 months.

Preferably, in said use, the active component is in an amount up to 10% wt of the paint product, more preferably up to 6.5% wt.

In another aspect, the present invention relates to the use of the active component for paint products as above described for activating a surface, said use comprising the step of diluting the active component into a paint product and applying the paint product on the surface at least once.

The dilution can be increased by further adding a solvent, preferably a water-based solvent, more preferably water, to the paint product.

As said above, the surface can be an internal or external surface, either in industrial or civil buildings or facilities.

Preferably, the step of dilution of the paint product achieves a concentration of at least 5% wt of the active component.

The present invention thus relates also to a paint product comprising the active component as above described.

Preferably, the paint product comprises at least 5% wt of the active component.

In other preferred embodiments, the paint product comprises up to 10% wt of the active component, more preferably up to 6.5%wt.

More preferably, said paint product is a water-based acrylic paint.

In a further aspect, the present invention concerns a process of preparing the active component above described, said process comprising the steps of:
a) providing at least one active agent against insects;
b) providing at least one synergistic agent;
c) microencapsulating or adsorbing on a mineral adsorbent said at least one synergistic agent in a mixture together with the at least one active agent or separately and independently of the latter; and
d) mixing with additives to obtain an active component.

It should be understood that all aspects identified as preferred and advantageous for the active component are to be deemed as similarly preferred and advantageous also for the processes of preparation and uses of the same.

It should be also understood that all the combinations of preferred aspects of the active component of the invention, as well as of processes of preparation and uses, as above reported, are to be deemed as hereby disclosed.

Below are working examples of the present invention provided for illustrative purposes.

### EXAMPLES

### Example 1

An active component was prepared according to the present invention, by mixing the following compounds (wt % based on the active component weight):

| | |
|---|---|
| Water | 48.00% |
| Resin (acrylic resin) | 8.00% |
| Inerts (mix of calcium carbonate, diatomite, kaolin) | 24.00% |
| Microcapsules comprising active agent | 1.50% |
| Microcapsules comprising synergists PBO | 3.00% |
| Free PBO | 3.00% |
| Free active agent | 0.50% |
| TiO2 | 5.00% |
| Pore-forming agent | 1.50% |
| Propylene Glycol | 2.00% |
| Humectante | 0.20% |
| Film-forming agent | 0.50% |
| Dispersant agent | 0.50% |
| Antioxidants | 0.25% |
| Anti-foaming agent | 0.25% |
| Surfactant | 0.50% |
| Bactericidal agent | 0.65% |
| Antifungal agent | 0.65% |

### Example 2

An active component was prepared according to the present invention, by mixing the following compounds (wt % on the active component weight):

| | |
|---|---|
| Water | 34.00% |
| Resin (acrylic resin) | 20.00% |
| Inerts (mix of calcium carbonate, diatomite, kaolin) | 25.00% |
| Modified sepiolite comprising a mixture of active | 3.50% |
| agent and PBO | |
| Free active agent | 0.50% |
| TiO₂ | 10.00% |
| Pore-forming agent | 1.50% |
| Propylene Glycol | 2.00% |
| Humectante | 0.50% |
| Film-forming agent | 0.50% |
| Dispersant agent | 0.50% |
| Antioxidants | 0.25% |
| Anti-foaming agent | 0.25% |
| Surfactant | 0.50% |
| Bactericidal agent | 0.50% |
| Antifungal agent | 0.50% |

### Example 3

An active component was prepared according to the present invention, by mixing the following compounds (wt % based on the active component weight):

| | |
|---|---|
| Water | 48.00% |
| Resin (acrylic resin) | 8.00% |
| Inerts (mix of calcium carbonate, diatomite, kaolin) | 24.00% |
| Microcapsules comprising 25% of active agent | 1.50% |
| Microcapsules comprising 25% of PBO | 3.00% |
| Free PBO | 2.85% |
| Free active agent | 0.475% |
| TiO2 | 5.00% |
| Pore-forming agent | 1.50% |
| Propylene Glycol | 2.00% |
| Humectante | 0.20% |
| Film-forming agent | 0.50% |
| Dispersant agent | 0.50% |
| Antioxidants | 0.25% |
| Anti-foaming agent | 0.25% |
| Surfactant | 0.50% |
| Bactericidal agent | 0.65% |
| Antifungal agent | 0.65% |

### Example 4

A paint has been prepared, having the following composition:

| | |
|---|---|
| water | 26.549% |
| ammonia (sol. 30%) | 0.064% |
| sodium salt of carboxymethylcellulose | 0.341% |
| methylhydroxypropylcellulose | 0.051% |
| pigment inorganic color blue | 0.004% |
| sodium hydroxide (sol. 10%) | 1.896% |
| calcined kaolin | 3.161% |
| zirconia/alumina-treated rutile pigment | 4.172% |
| micronized calcium carbonate | 31.606% |
| calcite | 6.321% |
| calcium carbonate | 18.964% |
| VINAVIL 03V 8496/30 (supplier: Vinavil SpA) | 5.689% |
| Pine oil | 0.019% |
| MERGAL ® K14 (supplier: Troy Corp.) Isothiazolinone | 0.196% |
| preservative having a broad spectrum of activity against | |
| bacteria, yeasts, fungi and molds | |
| Additives (dispersing agents, thickening agents, | 0.967% |
| humectants, coalescing agents, antifoaming agents) | |

wherein “%” means wt % based on the paint weight.

The following active components have been added to samples of the paint above:

### Example 4.1

active component 1 (concentration 25%), providing 2.5wt % of Pyrethrum and 2.5wt % of microcapsules comprising PBO, based on the final paint weight,

### Example 4.2

active component 2 (concentration 25%), providing 2wt % of Permetrin, 2wt % of Cipermetrin, 0.5wt % of Citronella, and 2wt % of microcapsules comprising PBO, based on the final paint weight,

### Example 4.3

active component 1 (concentration 25%), providing 1.25wt % of Pyrethrum and 1.25wt % of microcapsules comprising PBO, based on the final paint weight,

### Example 4.4

active component 2 (concentration 25%), providing lwt % of Permetrin, lwt % of Cipermetrin, 0.25wt % of Citronella, and lwt % of microcapsules comprising PBO, based on the final paint weight.

### Example 5

The paint obtained by the Example 4.2, i.e. by adding the active component 2 providing providing 2wt % of Permetrin, 2wt % of Cipermetrin, 0.5wt % of Citronella, and 2wt % of microcapsules comprising PBO, has been tested to evaluate the efficacy in killing target insects, i.e. Aedes albopictus mosquitos, through a forced contact test (tile test—insecticide efficacy).

The test has been performed according to the protocols based on the indications supplied by the guidelines of the European Commission: Technical Notes for Guidance. PRODUCT TYPE 18—INSECTICIDES, ACARICIDES AND PRODUCTS TO CONTROL OTHER ARTHROPODS and PRODUCT TYPE 19—REPELLENTS AND ATTRACTANTS (only concerning arthropods). CA-Dec12-Doc.6.2.a -Final.

### Parameters of Evaluation

Knockdown: at the end of the period of contact the individuals which don't move or appear stunned or unable of coordinate movements are considered as knocked down. The insects in these conditions may die after some time or may recover and overcome the crisis especially if they are moved from the treated environment. The insects are so moved to a healthy environment in the same conditions of temperature, humidity, light and food/water availability according to the breeding requirements. The mortality rate is assessed during the following days.

Moribund: individuals which after 24 since insecticide contact period are in supine position slowly responding to external stimuli and those on ventral position exhibiting uncoordinated or sluggish movements are classified as moribund. A period of observation is taken to verify if moribund insects recover or die. Dead insects, previously moribund, are counted as dead at 24 hours.

Mortality: individuals which don't show any movement and which don't react to external stimuli (i.e. when touched with a pair of tweezers) are considered as dead.

Alive: individuals which don't show any behavioral alterations.

Moving: the mosquitoes repelled move from the treated cage to the untreated one.

### Test Design—Tile Test

The test was conducted on 20×20 cm ceramic tiles using the side up as non-porous surface.

On each tile the product was applied by a Pasteur pipette and then smeared on the whole surface with a plastic sheet. The product was applied two times, the first time was applied the dosage of 1 L/8 m², after 45 minutes the same dosage was applied a second time, to reach the dosage of 1 L/4 m² 4 treated replications with 20 adults insects each were used.

2 replications treated with just water were used as negative controls.

Once the surfaces were dry, the insects were placed on the tiles under transparent plastic cup (12 cm diameter and 6 cm height) to prevent escaping and thus ensuring the contact with the treated surface.

### Data Recording

Observation of knockdown was recorded after 60 minutes. Mortality was recorded at 24 hours after the application.

### Results

The results of the test have been reported in the Tables below.

T0 - Jul. 7th, 2016

| | TREATED TILES | | | | | CONTROL TILES | | |
|---|---|---|---|---|---|---|---|---|
| | (N. knocked down insects) | | | | | (N. knocked down insects) | | |
| Time | 1 | 2 | 3 | 4 | Mean (%) ± SEM | 1 | 2 | Mean % |
| 60 min | 20 | 20 | 20 | 20 | 100.00 ± 0.00 | 0 | 0 | 0.00 |
| Moribund 24 h | 0 | 0 | 0 | 0 | 0.00 ± 0.00 | 0 | 0 | 0.00 |
| Dead 24 h | 20 | 20 | 20 | 20 | 100.00 ± 0.00 | 0 | 0 | 0.00 |
| Alive 24 h | 0 | 0 | 0 | 0 | 0.00 ± 0.00 | 20 | 20 | 100.00 |

| TREATED TILES | | | | | | | CONTROL TILES | | |
|---|---|---|---|---|---|---|---|---|---|
| % data | | | | mean | dev st | sem | % data | | mean |
| 100 | 100 | 100 | 100 | 100 | 0.00 | 0.00 | 0 | 0 | 0 |
| 0 | 0 | 0 | 0 | 0 | 0.00 | 0.00 | 0 | 0 | 0 |
| 100 | 100 | 100 | 100 | 100 | 0.00 | 0.00 | 0 | 0 | 0 |
| 0 | 0 | 0 | 0 | 0 | 0.00 | 0.00 | 100 | 100 | 100 |

### Conclusions

The insecticide efficacy was very clear, as the complete knockdown of the mosquitoes after 60 minutes was caused. 100% of the mosquitoes were dead after 24 hours.

### Example 6

The paint obtained by the Example 4.2, i.e. by adding the active component 2 providing providing 2wt % of Permetrin, 2wt % of Cipermetrin, 0.5wt % of Citronella, and 2wt % of microcapsules comprising PBO, has been tested to evaluate the efficacy in killing and repelling target insects, i.e. Aedes albopictus mosquitos.

The test has been performed according to the protocols based on the indications supplied by the guidelines of the European Commission: Technical Notes for Guidance. PRODUCT TYPE 18—INSECTICIDES, ACARICIDES AND PRODUCTS TO CONTROL OTHER ARTHROPODS and PRODUCT TYPE 19—REPELLENTS AND ATTRACTANTS (only concerning arthropods). CA-Dec12-Doc.6.2.a-Final.

### Parameters of Evaluation

Knockdown: at the end of the period of contact the individuals which don't move or appear stunned or unable of coordinate movements are considered as knocked down. The insects in these conditions may die after some time or may recover and overcome the crisis especially if they are moved from the treated environment. The insects are so moved to a healthy environment in the same conditions of temperature, humidity, light and food/water availability according to the breeding requirements. The mortality rate is assessed during the following days.

Moribund: individuals which after 24 since insecticide contact period are in supine position slowly responding to external stimuli and those on ventral position exhibiting uncoordinated or sluggish movements are classified as moribund. A period of observation is taken to verify if moribund insects recover or die. Dead insects, previously moribund, are counted as dead at 24 hours.

Mortality: individuals which don't show any movement and which don't react to external stimuli (i.e. when touched with a pair of tweezers) are considered as dead.

Alive: individuals which don't show any behavioral alterations.

Moving: the mosquitoes repelled move from the treated cage to the untreated one.

### Test Design

Insecticidal test: the test was conducted on 20×20 cm ceramic tiles using the side up as non-porous surface.

On each tile the product was applied by a Pasteur pipette and then smeared on the whole surface with a plastic sheet. The product was applied two times, the first time was applied the dosage of 1 L/8 m², after 45 minutes the same dosage was applied a second time, to reach the dosage of 1 L/4 m².

4 treated replications with 20 adult insects each were used.

2 replications treated with just water were used as negative controls.

Once the surfaces were dry, the insects were placed on the tiles under WHO cones (8.8 cm diameter and 6 cm height) to prevent escaping and thus ensuring the contact with the treated surface.

Repellency test: four treated tiles were used to build a cage while the two remaining sides were done of plexiglass to permit the observation of the insects. On one side a whole of 45 mm diameter put in communication, through a 10 cm long tube, a second untreated cage. The connection tube is done of metallic mesh, to permit the repellent evaporate and do not concentrate into the second cage. The second cage is done by a metallic frame and nylon mosquito net.

The treated tiles are the same used for the insecticidal test, they were used as soon the tile forced contact was completed (around 5 hours after the tile treatment). 20 mosquitoes were released into the treated cage.

### Data Recording

Insecticidal Test: tile test was performed at T0 (just after treatment and tile drying), at T30 (30 days after treatment) and T120 (120 days after treatment). Knockdown was recorded at 2, 5, 7, 10, 15 and 60 minutes. Mortality was recorded every 24 hours after the beginning of the exposure of the insects to the insecticide, until no moribund insects were present. At the T0 only observations at 60 minutes and at 24 hours were performed.

Repellency Test: was performed at T0 and T30. At T0 insects present in both of the cages were recorded at 4 and 24 hours while at T30 days observations were performed every 5 minutes up to 30 minutes, then at 4 and 24 hours.

### Results

The results of the test have been reported in the Tables below.

Insecticidal Test:

TABLE 1a
T0 - Jul. 7^{th}, 2016

| | TREATED TILES | | | | | CONTROL TILES | | |
|---|---|---|---|---|---|---|---|---|
| | N. knocked down insects | | | | | N. knocked down insects | | |
| Time | Treat. 1 | Treat. 2 | Treat. 3 | Treat. 4 | Mean (%) ± SEM | Cont. 1 | Cont. 2 | Mean % |
| 60 min | 20 | 20 | 20 | 20 | 100.00 ± 0.00 | 0 | 0 | 0.00 |
| Moribund 24 h | 0 | 0 | 0 | 0 | 0.00 ± 0.00 | 0 | 0 | 0.00 |
| Dead 24 h | 20 | 20 | 20 | 20 | 100.00 ± 0.00 | 0 | 0 | 0.00 |
| Alive 24 h | 0 | 0 | 0 | 0 | 0.00 ± 0.00 | 20 | 20 | 100.00 |

TABLE 1b
T30 - Aug. 6^{th}, 2016

| | TREATED TILES | | | | | CONTROL TILES | | |
|---|---|---|---|---|---|---|---|---|
| | N. knocked down insects | | | | | N. knocked down insects | | |
| Time | Treat. 1 | Treat. 2 | Treat. 3 | Treat. 4 | Mean (%) ± SEM | Cont. 1 | Cont. 2 | Mean % |
| 2 min | 0 | 0 | 0 | 0 | 0.00 ± 0.00 | 0 | 0 | 0.00 |
| 5 min | 6 | 8 | 12 | 5 | 38.75 ± 8.94 | 0 | 0 | 0.00 |
| 7 min | 12 | 15 | 17 | 7 | 63.75 ± 12.56 | 0 | 0 | 0.00 |
| 10 min | 17 | 19 | 20 | 15 | 88.75 ± 6.40 | 0 | 0 | 0.00 |
| 15 min | 20 | 20 | 20 | 20 | 100.00 ± 0.00 | 0 | 0 | 0.00 |
| 60 min | 20 | 20 | 20 | 20 | 100.00 ± 0.00 | 0 | 0 | 0.00 |
| Moribund 24 h | 0 | 0 | 0 | 0 | 0.00 ± 0.00 | 0 | 0 | 0.00 |
| Dead 24 h | 20 | 20 | 20 | 20 | 100.00 ± 0.00 | 0 | 0 | 0.00 |
| Alive 24 h | 0 | 0 | 0 | 0 | 0.00 ± 0.00 | 20 | 20 | 100.00 |

TABLE 1c
T120 - Nov. 7^{th}, 2016

| | TREATED TILES | | | | | CONTROL TILES | | |
|---|---|---|---|---|---|---|---|---|
| | N. knocked down insects | | | | | N. knocked down insects | | |
| Time | Treat. 1 | Treat. 2 | Treat. 3 | Treat. 4 | Mean (%) ± SEM | Cont. 1 | Cont. 2 | Mean % |
| 2 min | 1 | 2 | 0 | 1 | 5.00 ± 2.36 | 0 | 0 | 0.00 |
| 5 min | 7 | 6 | 7 | 4 | 30.00 ± 4.08 | 0 | 0 | 0.00 |
| 7 min | 11 | 14 | 9 | 12 | 57.50 ± 6.01 | 0 | 0 | 0.00 |
| 10 min | 19 | 18 | 15 | 15 | 83.75 ± 5.95 | 0 | 0 | 0.00 |
| 15 min | 20 | 20 | 20 | 20 | 100.00 ± 0.00 | 0 | 0 | 0.00 |
| 60 min | 20 | 20 | 20 | 20 | 100.00 ± 0.00 | 0 | 0 | 0.00 |
| Moribund 24 h | 0 | 0 | 0 | 0 | 0.00 ± 0.00 | 0 | 0 | 0.00 |
| Dead 24 h | 20 | 20 | 20 | 20 | 100.00 ± 0.00 | 0 | 0 | 0.00 |
| Alive 24 h | 0 | 0 | 0 | 0 | 0.00 ± 0.00 | 20 | 20 | 100.00 |

TABLE 2a
T0-Jul. 7^{th}, 2016

| Number of mosquitoes present | |
|---|---|
| Treated Cage | Untreated Cage |

| | Alive | Dead | Alive | Dead |
|---|---|---|---|---|
| 4 hours | 0 | 19 | 0 | 1 |
| 24 hours | 0 | 19 | 0 | 1 |

TABLE 2b
T30-Aug. 6^{th}, 2016

| Number of mosquitoes present | |
|---|---|
| Treated Cage | Untreated Cage |

| | Alive | Dead | Alive | Dead |
|---|---|---|---|---|
| 5 min | 18 | 1 | 1 | 0 |
| 10 min | 14 | 1 | 5 | 0 |
| 15 min | 4 | 11 | 5 | 0 |
| 20 min | 4 | 11 | 5 | 0 |
| 25 min | 0 | 15 | 5 | 0 |
| 30 min | 0 | 16 | 4 | 0 |
| 4 hours | 0 | 16 | 4 | 0 |
| 24 hours | 0 | 18 | 2 | 0 |

### Conclusions

Insecticidal Test

Knockdown was recorded only at 1 hour at T0 (with a result of 100% of knockdown and mortality at 24 hours). At T30 and at T120 complete knockdown was reached at 15 minutes with a mortality of 100%.

Repellency Test

Repellency action was not evident: at T0 all the mosquitoes were dead after 4 hours (19 mosquitoes were present in the treated cage and 1 in the untreated cage; probably the insecticidal action did not give the time to the mosquitoes to move toward the second cage) and after 30 days since the treatment (at 24 hours) 2 alive mosquitoes were present in the untreated cage and 18 were dead in the treated one.

1. An active component for paint products, said component comprising at least one active agent against insects, at least one synergistic agent and additives, said active agent against insects being an insect repellent, an insecticide, or a mixture thereof, wherein said at least one active agent against insects is microencapsulated or adsorbed on a mineral adsorbent, and said at least one synergistic agent is microencapsulated or adsorbed on a mineral adsorbent together with the at least one active agent against insects or separately and independently of the latter.

2. The active component for paint products of claim 1, wherein said at least one active agent is in an amount up to 40 wt %, based on the weight of the active component.

3. The active component for paint products of claim 2, wherein said at least one synergistic agent is selected from piperonyl butoxide, sesame, sulfoxide, and mixtures thereof.

4. The active component for paint products of claim 1, wherein said mineral adsorbent is zeolite or sepiolite.

5. The active component for paint products of claim 1, wherein said insect repellent is selected from the group consisting of Achillea alpine, alpha-terpinene, Basil, Callicarpa Americana, Breadfruit, Camphor, Capsicum, Carvacrol, Castor oil, Catnip oil, Cedar oil, Celery extract, Cinnamon, Citronella oil, Oil of cloves, Eucalyptus oil, Fennel oil, Garlic, Geranium oil, Lavender, Lemon eucalyptus, Lemongrass oil, Marigolds, Marjoram, Neem oil, Oleic acid, Pennyroyal, Pyrethrum, Rosemary, Sophora flavescens, Spanish Flag, Tea tree oil, Thyme, Yellow Nightshade, Andrographis paniculata, N,N-Diethyl-meta-toluamide (DEET), picaridin, ethyl butylacetylamino-propionate, p-menthane-3,8-diol, and combinations thereof.

6. The active component for paint products of claim 1, wherein said insecticide is selected from the group consisting of Organochlorides, Organophosphates, Carbamates, Pyrethroids, Neonicotinoids, Ryanoids, Insect growth regulators, Plant-derived insecticides, Inorganic insecticides, and combinations thereof.

7. The active component for paint products of claim 1, further comprising a sanitizer, said sanitizer being selected from the group consisting of aldehydes, anilides, biguanides, bis-phenols, quaternary ammonium compounds, cetyl pyridium chloride, cetrimide, alexidine, chlorhexidine, chlorhexidine gluconate, chlorhexidine digluconate, chlorhexidine diacetate, benzalkonium chloride, o-phthalaldehyde, and combinations thereof.

8. A method for activating a surface, said method comprising the steps of diluting the active component of claim 1 into a paint product and applying the paint product on the surface at least once.

9. A paint product comprising the active component of claim 1.

10. A process of preparing the active component for paint products of claim 1, said process comprising the steps of:
a) providing at least one active agent against insects;
b) providing at least one synergistic agent;
c) microencapsulating or adsorbing on a mineral adsorbent said at least one synergistic agent in a mixture together with the at least one active agent or separately and independently of the latter; and
d) mixing with additives to obtain an active component.
